(19) United States
(12) Patent Application Publication
(10) Pub. No.: US 2018/0210670 A1
(43) Pub. Date: Jul. 26, 2018

(54) STORAGE MANAGEMENT OF METADATA

(71) Applicant: HEWLETT-PACKARD DEVELOPMENT COMPANY, L.P., Houston, TX (US)

(72) Inventor: Russell Ian Monk, Bristol (GB)

(21) Appl. No.: 15/742,783

(22) PCT Filed: Nov. 4, 2015
(86) PCT No.: PCT/US2015/058950

§ 371 Date: Jan. 8, 2018

(51) Int. Cl. G06F 3/06; G06F 17/30

(52) U.S. Cl. CPC G06F 3/0638; G06F 17/30997; G06F 3/0653

(57) ABSTRACT

In one example, write request for input data record that includes input data and metadata associated with input data. If any input metadata are common metadata, and if length of a common metadata group hash formed from combined common metadata is less than sum of lengths of the input metadata that are common metadata, generate a common metadata hash record to include the common metadata group hash and the common metadata. If any input metadata are common metadata, and if length of a common data group hash formed from the common data is less than sum of lengths of the common data, generate a common data hash record to include the common data group hash and the common data. Generate an output data record to include the common metadata and data group hash of the hash records and include input metadata and data not in the generated hash records.

### BACKGROUND

Computer systems may include storage networks which may allow computing devices to access storage devices for storing data for later retrieval. The computing devices may store data records as well as metadata which describes the content of the data records.

### BRIEF DESCRIPTION OF THE DRAWINGS

Examples are described in the following detailed description and in reference to the drawings, in which:

FIG. 1 depicts an example system for storage management of metadata in accordance with the techniques of the present disclosure;

FIGS. 2A through 2C depicts example systems for storage management of metadata in accordance with the techniques of the present disclosure:

FIG. 3A depicts an example flow chart of a process for storage management of metadata in accordance with the techniques of the present disclosure;

FIG. 3B depicts another example flow chart of a process for storage management of metadata in accordance with the techniques of the present disclosure;

FIGS. 4A through 4F depict example diagrams of storage management of metadata in accordance with the techniques of the present disclosure; and

FIG. 5 depicts an example block diagram showing a non-transitory, computer-readable medium that stores instructions for storage management of metadata in accordance with the techniques of the present disclosure.

### DETAILED DESCRIPTION

Computer systems may include storage networks which may allow computing devices to access storage devices for storing data for later retrieval. The computing devices may store data records as well as metadata which describes the content of the data records. However, storing data records and corresponding metadata may result in large amount of data being stored on the storage devices which increases the storage requirements of the system which may not be desirable.

In one example of the techniques of the present disclosure, disclosed is a computing device which may be configured to identify metadata where portions of the metadata are common among other metadata. The metadata may be unordered and may be combined with other metadata which is not common. The techniques of the present disclosure may help reduce the storage requirement for storing metadata by applying deduplication techniques (i.e. reducing storage of copies of the same records) to portions of the metadata that repeat or are common amongst other metadata. In other words, the deduplication techniques help reduce storing duplicated records by storing one copy of the record and then have subsequent requests point to the one stored copy. The deduplication techniques or functions may involve calculation of hash functions on the metadata and determination of which metadata is common.

In one example of the techniques of the present disclosure, disclosed is a computing device with a storage management module configured to process requests from host computing devices. The requests may include requests or commands to write data records to a storage device and read data records from the storage device.

In one example, the storage management module may respond to a write request to write an input data record that includes input data and input metadata associated with respective input data. The module checks if any input metadata are common metadata, and if length of a common metadata group hash formed from combined common metadata is less than sum of lengths of the input metadata that are common metadata. If so, then the module generates a common metadata hash record to include the common metadata group hash and the common metadata. The module checks if any input metadata are common metadata, and if length of a common data group hash formed from the common data is less than sum of lengths of the common data. If so, then the module generates a common data hash record to include the common data group hash and the common data. The module generates an output data record to include the common metadata group hash and common data group hash of the respective generated common metadata and data hash records and to include all input metadata and input data not included in the corresponding generated common metadata and data hash records.

In another example, the storage management module may be configured to respond to an update request to update an output data record. In this case, the module retrieves the requested output data record which includes a common data group hash and a common metadata group hash, retrieves a common data hash record that includes the common data group hash and corresponding common data, and retrieves a common metadata hash record that includes the metadata group hash and corresponding metadata. The module then checks for any changes to the common data and metadata to determine whether to update or rewrite the output data record. The module rewrites the retrieved output data record which includes an updated common data group hash and updated metadata group hash.

In another example, the storage management module may be configured to respond to a read request to read an output data record. In this case, the module retrieves the requested output data record which includes any common data group hash, any common metadata group hash, and any input metadata and input data. The module retrieves any common data hash record that includes the common data group hash and corresponding common data, and retrieves any common metadata hash record that includes the common metadata group hash and corresponding common metadata. The module then combines the common data from the common data hash record and the common metadata from the common metadata hash record to form the response output record to be returned in response to the request.

In another example, the storage management module may be configured to determine whether the input data of the input data record is common data based on whether it is same as input data of another input data record. The module may determine whether the input metadata of the input data record is common metadata based on whether it is same as input metadata of another input data record.

In another example, the storage management module may be configured to determine the common metadata group is a sorted list of common metadata of the input data record, and determine the common data group is a list of input data of an input data record corresponding to the common metadata group and sorted in the same order as the common metadata group.

In this manner, in some examples, the present disclosure discloses techniques to help reduce storage requirements of computer systems which may help increase the performance of computer systems. That is, such techniques may help reduce the storage requirement for storing metadata by applying deduplication techniques (i.e. reducing storage of copies of the same records) to portions of the metadata that repeat or are common amongst other metadata.

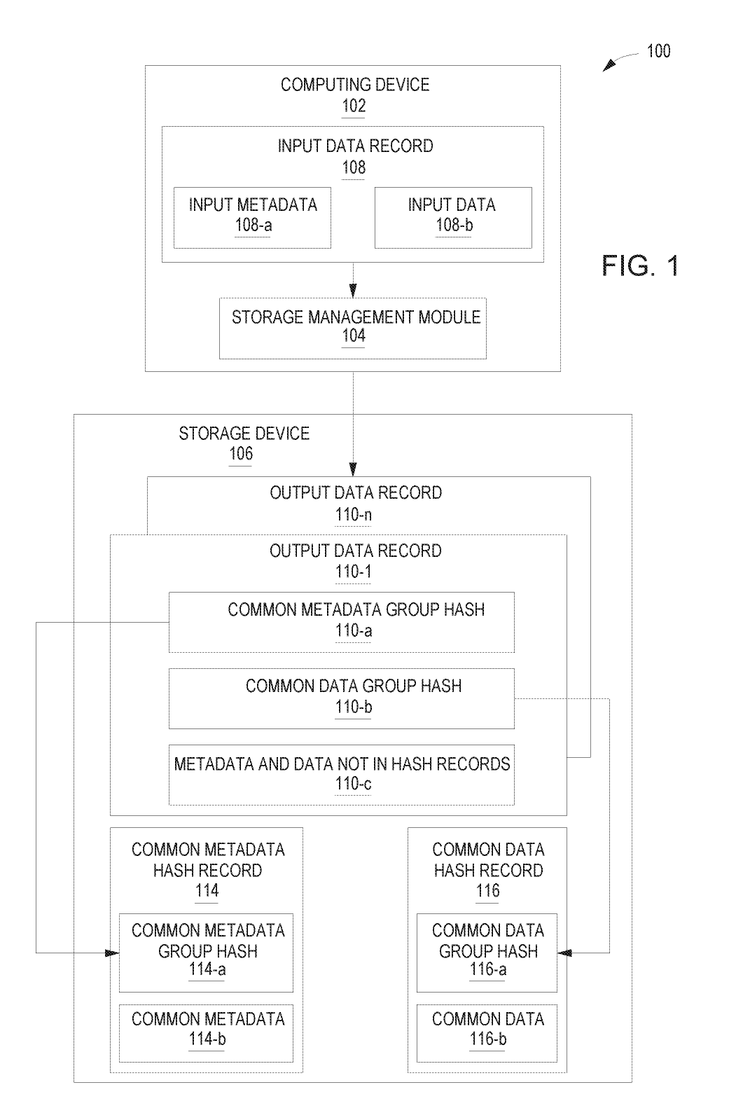

FIG. 1 depicts an example system 100 for storage management of metadata in accordance with the techniques of the present disclosure. The system 100 includes a computing device 102 configured with a storage management module 104 to provide storage management of metadata in accordance with an example of the techniques of the present disclosure.

The storage management module 104 may be configured to communicate with other computing devices such as host computing devices to allow the computing devices to access storage provided by storage device 106 over a storage network. In one example, the storage network may be a Storage Area Network (SAN) or other network.

The storage management module 104 may be configured to process requests from host computing devices to process input records 108 and write them as output data records 110 (110-1 through 110-n, where n is any number) to storage device 106 and read data records from the storage device. The requests may include requests or commands to write data records to a storage device and read data records from the storage device. The module 104 may respond to the requests with acknowledgments in the form of messages with data according to particular protocols and the like.

In one example, storage management module 104 may be configured to respond to a write request to write an input data record 108. In one example, input data record 108 includes input data 108-b and input metadata 108-a associated with respective input data. In some examples, input data 108-b and input metadata 108-a may comprise fields or entries containing blocks or groups of data.

The module 104 is configured to check for two conditions. The first condition includes checking if any input metadata 108-a are common metadata. The second condition includes checking if length of a common metadata group hash 110-a formed from combined common metadata is less than sum of lengths of the input metadata 108-a that are common metadata. If first and second conditions are true, then module 104 generates a common metadata hash record 114 to include the common metadata group hash 114-a (which is a copy of common metadata group hash 110-a) and common metadata 114-b. In one example, module 104 copies common metadata group hash 110-a to common metadata group hash 114-a. In addition, module 104 copies input metadata 108-a that is common metadata to common metadata 114-b. As shown, common metadata group hash 110-a points to (makes reference) to common metadata hash group hash 114-a.

The module 104 may be configured to check for two additional conditions. The third condition includes checking any input metadata 108-a are common metadata. The fourth condition includes checking if length of a common data group hash 116-a formed from the common data is less than sum of lengths of the common data. If these conditions are true, then module 104 generates a common data hash record 116 to include the common data group hash 116-a (which is a copy of common data group hash 110-b) and common data 116-b. In one example, module 104 copies common data group hash 110-b to common data group hash 116-a. In addition, module 104 copies input data 108-b that is common data to common data 116-b. As shown, common data group hash 110-b points to (makes reference) to common data group hash 116-a.

The module 104 then generates an output data record 110 to include the common metadata group hash 110-a and common data group hash 110-b of the respective generated common metadata hash record 114 and common data hash record 116 and to include all input metadata and input data 110-c not included in the corresponding generated common metadata and data hash records. In some examples, common metadata hash records 114 and common data hash records 116 may be the same, they are hash records which include a hash and data. The hash records may be stored in the same database without any relationship or identifier to indicate the type of hash record. The type of hash record and relationship may be indicated from where it was referenced in output data record 110. The relationship may be provided with output data record between common metadata group hash 114-a and common data group hash 116-a since a link or pointer is provided to associate the metadata with the data. In another example, the relationship may be as follows (where -> symbol represents a reference or pointer): common metadata group hash->common data group list, common metadata group hash->common data group hash, common metadata group list->common data group list or common metadata group list->common data group hash (depending on the size of each element).

In another example, storage management module 104 may be configured to respond to an update request to update an output data record 110. In one example, module 104 may perform a periodic scrub process or operation to check or determine whether metadata and data are common so to update the records with combined hashes. In one case, module 104 retrieves the requested output data record 110 which includes a common data group hash 110-b and common metadata group hash 110-a, retrieve common data hash record 116 that includes common data group hash 116-a and corresponding common data 116-b, retrieve common metadata hash record 114 that includes metadata group hash 114-a and corresponding metadata 114-b. The module 104 then checks for any changes to common data and metadata to determine whether to update or rewrite the output data record. The module rewrites the retrieved output data record which includes an updated common data group hash and updated metadata group hash. In one example, the update request may include a record identifier to identify output data record 110 such as a key, unique address and the like.

In another example, storage management module 104 may be configured to respond to a read request to read an output data record 110. In one case, module 104 retrieves the requested output data record 110 which includes any common data group hash 110-b, any common metadata group hash 110-a, and any input metadata and input data 110-c not in hash records, retrieve any common data hash record 116 that includes common data group hash 116-a and corresponding common data 116-b, and retrieve any common metadata hash record 114 that includes common metadata group hash 114-a and corresponding common metadata 114-b. The module then combines the common data from the common data hash record and the common metadata from the common metadata hash record to form the response output record to be returned in response to the request. In one example, the update request may include a record identifier to identify output data record 110 such as a key, unique address and the like.

In another example, storage management module 104 may be configured to determine or check whether input data 108-b of the input data record 108 is common data based on whether it is same as input data of another input data record. The module 104 may also determine or check whether input metadata 108-a of input data record 108 is common metadata based on whether it is same as input metadata of another input data record.

In another example, storage management module 104 may be configured to determine or check if the common metadata group is a sorted list of common metadata of the input data record 108. The module 104 may determine or check if the common data group is a list of input data of an input data record 108 corresponding to the common metadata group and sorted in the same order as the common metadata group.

The storage device 106 may be defined as any electronic means to store data for later retrieval. The storage device 106 may include storage volumes which may be logical units of data that can be defined across multiple storage devices. The computing device 102 may receive from host computing devices Input/Output (IO) requests which may include requests to read data from storage device 106 as volumes and requests to write data to the storage devices as volumes. The storage device 106 may refer to a physical storage element, such as a disk-based storage element (e.g., hard disk drive, optical disk drive, etc.) or other type of storage element (e.g., semiconductor storage element). In one example, multiple storage devices within a storage subsystem can be arranged as an array configuration.

The computing device 102 may be configured to communicate with other computing devices such as host computing devices over network using network techniques. The network techniques may include any means of electronic or data communication. The network may include a local area network, Internet and the like. The network techniques may include Fibre Channel network, SCSI (Small Computer System Interface) link, Serial Attached SCSI (SAS) link and the like. The network techniques may include switches, expanders, concentrators, routers, and other communications devices.

In examples described herein, computing device 102 may communicate with components implemented on separate devices or system(s) via a network interface device of the computing device. In another example, computing device 102 may communicate with storage device 106 via a network interface device of the computing device and storage device. In another example, computing device 102 may communicate with other computing devices via a network interface device of the computing device. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, or the like, or a combination thereof. In some examples, a computer network may include a telephone network (e.g., a cellular telephone network).

The system 100 of FIG. 1 shows an example computing device 102 and should be understood that other configurations may be employed to practice the techniques of the present disclosure. For example, system 100 may be configured to include a plurality of computing devices 102 to communicate with a plurality of other computing devices such as host computing devices. In another example, storage device 106 is shown as a single component but it should be understood that the storage device may be implemented as a plurality of storage devices distributed across a plurality of computing devices 102. In another example, storage management module 104 is shown as a single component but it should be understood that the module may be plurality of modules distributed across a plurality of computing devices 102. The input data record 108 and output data records 110 are shown as having particular data elements, but it should be understood that the records may include a different number of data elements as well as a different combination of elements. Likewise, hash records 114 and 116 are shown as having particular data elements, but it should be understood that the hash records may include a different number of data elements as well as a different combination of elements. The components of system 100 may be implemented in hardware, software or a combination thereof. In one example, module 104 may be implemented in hardware, software or a combination thereof. In another example, the functionality of the components of system 100 may be implemented using technology related to Personal Computers (PCs), server computers, tablet computers, mobile computers and the like.

FIG. 1 shows system 100 to provide storage management of metadata. The system 100 may include computer-readable storage medium comprising (e.g., encoded with) instructions executable by a processor to implement functionalities described herein in relation to FIG. 1. In some examples, the functionalities described herein in relation to instructions to implement storage management module 104 functions, and any additional instructions described herein in relation to storage medium, may be implemented as engines or modules comprising any combination of hardware and programming to implement the functionalities of the modules or engines, as described below. The functions of module 104 may be implemented by a computing device which may be a server, blade enclosure, desktop computer, laptop (or notebook) computer, workstation, tablet computer, mobile phone, smart device, or any other processing device or equipment including a processing resource. In examples described herein, a processor may include, for example, one processor or multiple processors included in a single computing device or distributed across multiple computing devices.

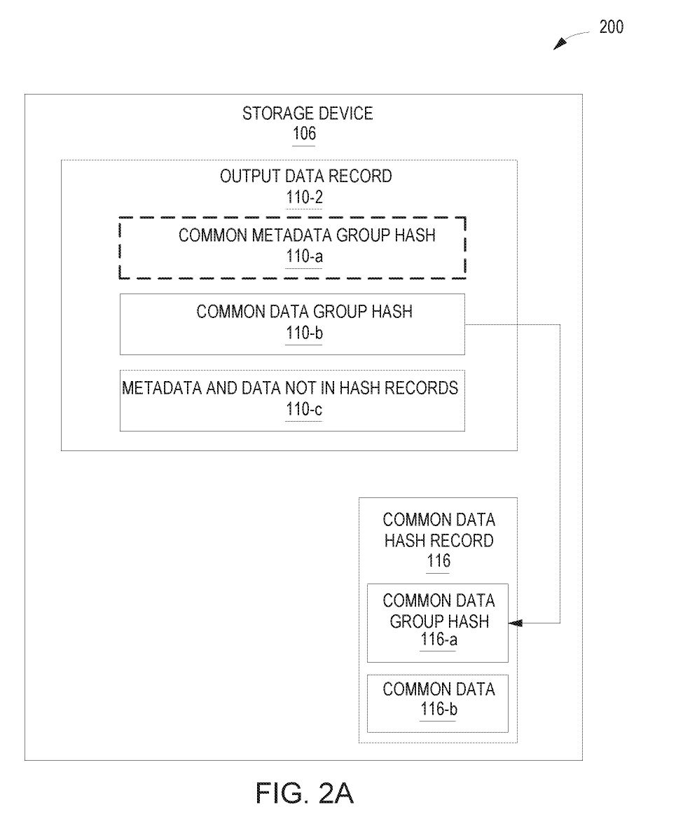

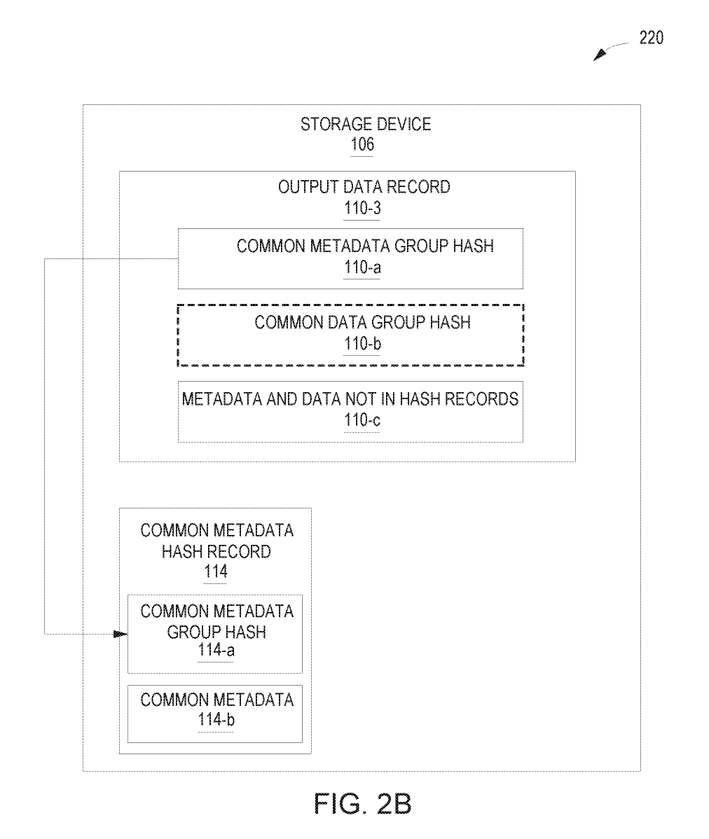

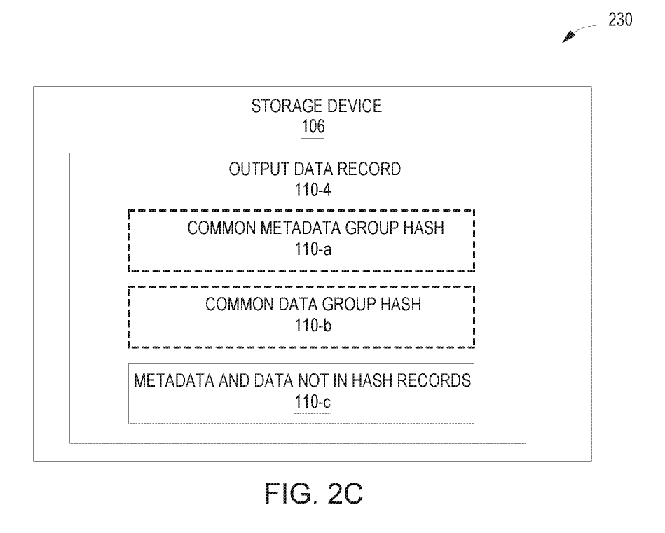

FIGS. 2A through 2C depicts example systems for storage management of metadata in accordance with an example of the present disclosure. As explained above in the context of FIG. 1, output data record 110-1 is shown as having a particular arrangement. However, it should be understood that output data record 110-1 may have other arrangements as explained below.

FIG. 2A is an example diagram 200 showing another example of an output data record 110-2. In this case, output data record 110-2 includes a common data group hash 110-b and metadata and data 110-c not in hash records. In this example, output data record 110-2 does not include common metadata group hash 110-a shown as a dotted-line box. Here, module 104 determined input record 108 did not have metadata that was common to generate common metadata group hash 110-a. In addition, as a result, no common metadata hash record 114 was generated. However, a common data hash record 116 was generated with common data group hash 116-a being referenced by common data group hash 110-b, as shown by the arrow from 110-b to 116-a. In addition, input data 108-b that is found to be common is copied as common data 116-b to common data hash record 116.

FIG. 2B is an example diagram 220 showing another example of an output data record 110-3. In this case, output data record 110-3 includes a common metadata group hash 110-a and metadata and data 110-c not in hash records. However, output data record 110-3 does not include common data group hash 110-b shown as a dotted-line box. In this case, module 104 determined input record 108 did not have data that was common to generate common data group hash 110-b. In addition, as a result, no common data hash record 116 was generated. However, a common metadata hash record 114 was generated with common metadata group hash 114-a being referenced by common metadata group hash 110-a, as shown by the arrow from 110-a to 114-a. In addition, input metadata 108-a that is found to be common is copied as common metadata 114-b to common metadata hash record 114.

FIG. 2C is an example diagram 230 showing another example of an output data record 110-4. In this case, output data record 110-4 that includes metadata and data 110-c not in hash records. However, output data record 110-4 does not include common metadata group hash 110-a and common data group hash 110-b shown as dotted-line boxes. In this case, module 104 determined input record 108 did not have data that was common to generate common data group hash 110-b. In addition, as a result, no common data hash record 116 was generated. Likewise, In this case, module 104 determined input record 108 did not have metadata that was common to generate common metadata group hash 110-a. In addition, as a result, no common metadata hash record 114 was generated. Furthermore, input data 108 that is found to not have any common metadata 108-a and 108-b and the input data is copied as metadata and data not hash records 110-c.

FIGS. 2A through 2C depicts example systems for storage management of metadata in accordance with an example of the present disclosure. As explained above, output data records 110 are shown as having particular arrangements. However, it should be understood that output data records 110 may have other arrangements.

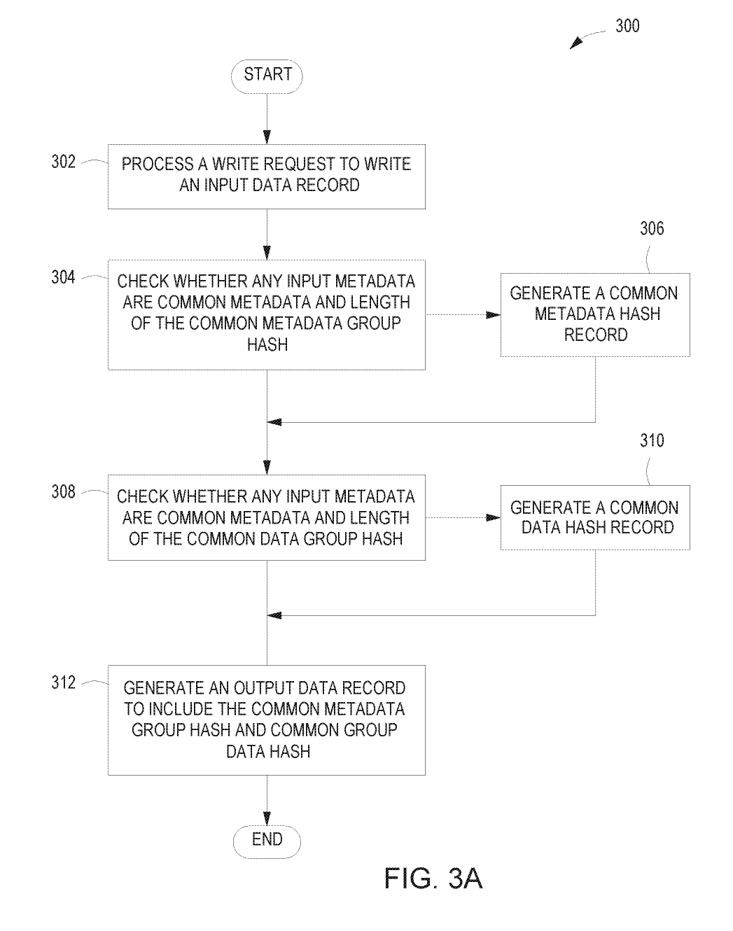

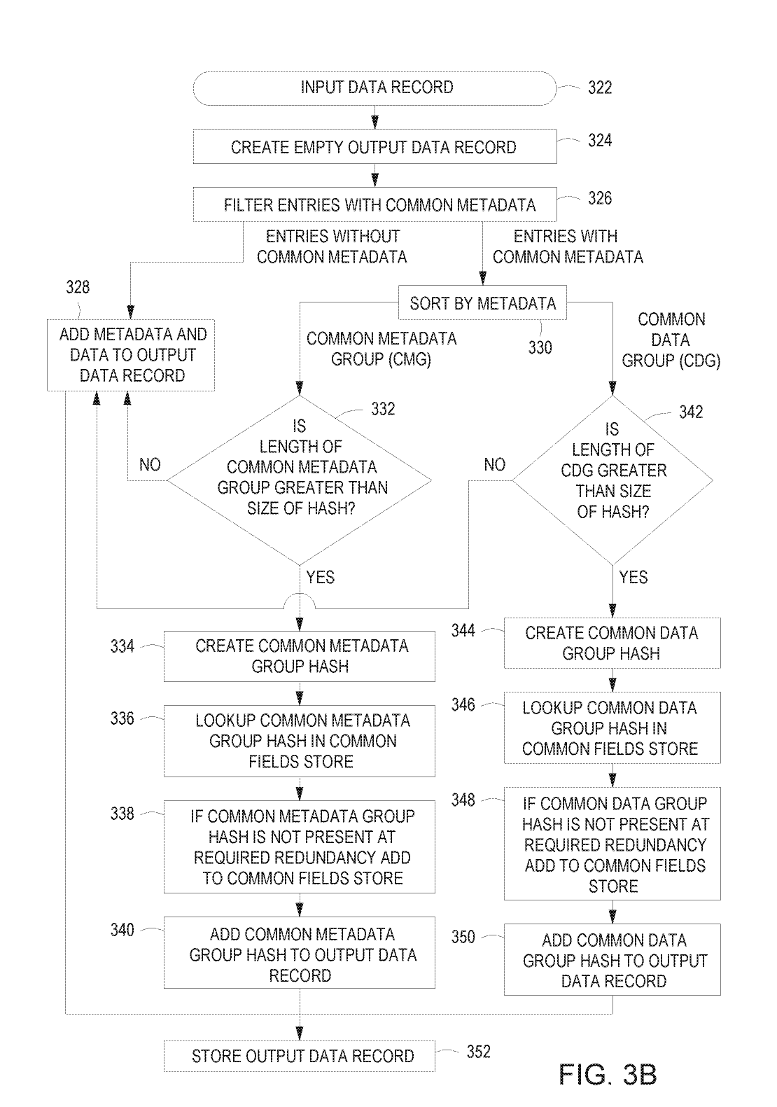

FIG. 3A depicts an example flow chart 300 of a process for storage management of metadata in accordance with an example of the techniques of the present disclosure. To illustrate operation, it may be assumed that process 300 employs system 100 which includes computing device 102 configured to provide storage management of metadata according to the techniques of the present disclosure and functionality described herein.

It should be understood the process depicted in FIG. 3A represents generalized illustrations, and that other processes may be added or existing processes may be removed, modified, or rearranged without departing from the scope and spirit of the present disclosure. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits. Application Specific Integrated Circuits (ASICs), or other hardware components associated with the system. Furthermore, the flow charts are not intended to limit the implementation of the present disclosure, but rather the flow charts illustrate functional information to design/fabricate circuits, generate software, or use a combination of hardware and software to perform the illustrated processes.

The process 300 may begin at block 302, where storage management module 104 processes a write request to write an input data record 108. In one example, input data record 108 includes input data 108-b and input metadata 108-a associated with respective input data. In another example, module 104 may receive the write request from a host computing device or other computing device. Processing proceeds to block 304.

At block 304, storage management module 104 checks whether any input metadata are common metadata and length of the common metadata group hash. In one example, module 104 checks if length of the common metadata group hash 110-a formed from combined common metadata is less than sum of lengths of the input metadata that are common metadata. If this condition is true, then processing proceeds to block 306. On the other hand, if this condition is not true, then processing proceeds to block 308.

At block 306, storage management module 104 generates a common metadata hash record 114. In one example, module 104 generates common metadata hash record 114 to include common metadata group hash 114-a and common metadata 114-b. Processing proceeds to block 308.

At block 308, storage management module 104 checks whether any input metadata are common metadata and length of the common data group hash 110-b In one example, module 104 checks if length of common data group hash 110-b formed from the common data is less than sum of lengths of the common data. If this condition is true, then processing proceeds to block 310. On the other hand, if this condition is not true, then processing proceeds to block 312.

At block 310, storage management module 104 generates a common data hash record 116. In one example, module 104 generates common data hash record 116 to include common data group hash 116-a and common data 116-b, based on whether any input metadata are common metadata. Processing proceeds to block 312.

At block 312, storage management module 104 generates an output data record 110 to include common metadata group hash 110-a and common data group hash 110-b. In one example, module 104 generates an output data record 110 to include common metadata group hash 110-a and common data group hash 110-b of the respective generated common metadata and data hash records. The output data record 110 is also to include all input metadata and input data 110-c not included in the corresponding generated common metadata hash and common data hash records. In one example, processing proceeds to End block. In another example, processing proceeds to further processing including proceeding back to block 302 for processing further write requests.

In another example, storage management module 104 may be configured to respond to an update request to update an output data record 110. In this case, module 104 retrieves the requested output data record 110 which includes a common data group hash 110-b and common metadata group hash 110-a, retrieve common data hash record 116 that includes common data group hash 116-a and corresponding common data 116-b, retrieve common metadata hash record 114 that includes metadata group hash 114-a and corresponding metadata 114-b, and rewrite the retrieved output data record 110 which includes an updated common data group hash and updated metadata group hash.

In another example, storage management module 104 may be configured to respond to a read request to read an output data record 110. In this case, module 104 retrieves the requested output data record 110 which includes any common data group hash 110-b, any common metadata group hash 110-a, and any input metadata and input data 110-c not in hash records, retrieve any common data hash record 116 that includes common data group hash 116-a and corresponding common data 116-b, and retrieve any common metadata hash record 114 that includes common metadata group hash 114-a and corresponding common metadata 114-b.

In another example, storage management module 104 may be configured to determine whether input data 108-b of the input data record 108 is common data based on whether it is same as input data of another input data record. The module 104 may also determine whether input metadata 106-a of input data record 108 is common metadata based on whether it is same as input metadata of another input data record.

In another example, storage management module 104 may be configured to determine the common metadata group is a sorted list of common metadata of the input data record 108. The module 104 may also determine the common data group is a list of input data of an input data record 108 corresponding to the common metadata group and sorted in the same order as the common metadata group.

The process 300 of FIG. 3A shows an example process and it should be understood that other configurations may be employed to practice the techniques of the present disclosure. For example, process 300 may be configured to process a plurality of input data records 108 and generate a plurality of output data records 110 to be stored across a plurality of storage devices 106.

FIG. 3B depicts an example flow chart 320 of a process for storage management of metadata in accordance with an example of the techniques of the present disclosure. To illustrate operation, it may be assumed that process 320 employs system 100 which includes computing device 102 configured to provide storage management of metadata according to the techniques of the present disclosure and functionality described herein.

The process 320 may begin at block 322, where storage management module 104 receives an input data record 108. In one example, module 104 processes a write request to write an output record 110 based on input data record 108 that includes input 108-b data and input metadata 108-a associated with respective input data. In another example, module 104 may receive the write request from a host computing device or other computing device. Processing proceeds to block 324.

At block 324, storage management module 104 creates an output data record 110 that is empty. In one example, module generates output data record 110 that is empty with no common metadata group hash 110-a, no common data group hash 110-b and no metadata and data not in hash records 110-c. Processing proceeds to block 326.

At block 326, storage management module 104 filters entries with common metadata. In one example, module 104 filters (checks or separates) input metadata 108-a (including entries or fields of the input metadata) to identify common metadata and metadata that is not common. If there are input fields or entries with common metadata, then processing proceeds to block 330. On the other hand, if there are input fields or entries with no common metadata, then processing proceeds to block 328.

At block 328, storage management module 104 adds metadata and data to output data record 110. In one example, module 104 copies input metadata 108-a and input data 108-b as metadata and data not in hash records 110-c of output data record 110. That is in this case, input metadata 108-a and input data 108-b did not have common data and thus the complete or verbose content of the input data was written to 110-c. Processing proceeds to block 352.

At block 330, storage management module 104 sorts the input data by input metadata 108-a. In one example, module 104 sorts input metadata 108-a to identify groups of common metadata and data. If there are common metadata as a group, then module 104 forms a common metadata group and processing proceeds to block 332. On the other hand, if there are common data as a group then module 104 forms a common data group and processing proceeds to block 342.

At block 332, storage management module 104 checks if length of common metadata group is greater than size of hash of common metadata group. If length of common metadata group is greater than size of hash of common metadata group, then processing proceeds to block 334. On the hand, if length of common metadata group is not greater than size of hash of common metadata group, then processing proceeds to block 328.

At block 334, storage management module 104 creates a common metadata group hash. In one example, storage management module 104 creates a common metadata group hash record 114. Processing proceeds to block 336.

At block 336, storage management module 104 performs a lookup of the common metadata group hash 110-a in a common fields store. In one example, module 104 checks whether common metadata group hash 110-a is present in the common fields store. In one example, the common fields store may be part of a database that is part of storage device 106. Processing proceeds to block 338.

At block 338, storage management module 104 checks if common metadata group hash 110-a is not present at a required redundancy. For example, to illustrate redundancy in an object store configuration, it may be specified that 3 copies of the object are to be stored to achieve a required level of reliability/resilience to error conditions. If only 2 copies are currently stored then a 3rd copy is to be written to achieve the specified redundancy. In addition, there may be a requirement that the copies are to be stored in a certain country or logical region. If common metadata group hash 110-a is not present at a required redundancy, then module 104 adds common metadata group hash 110-a to the common fields store. Processing proceeds to block 340.

At block 340, storage management module 104 adds the common metadata group hash to output data record 110. In one example, module 104 adds common metadata group hash 110-a to output data record 110. Processing proceeds to block 352.

At block 342, storage management module 104 checks if length of common data group is greater than size of hash of common data group. If length of common data group is greater than size of hash of common data group, then processing proceeds to block 344. On the hand, if length of common data group is not greater than size of hash of common data group, then processing proceeds to block 352.

At block 344, storage management module 104 creates a common data group hash 114. Processing proceeds to block 346.

At block 346, storage management module 104 performs a lookup of the common data group hash 110-b in a common fields store. In one example, the common fields store is a storage configuration as part of a database stored in storage device 106. Processing proceeds to block 348.

At block 348, storage management module 104 checks if common data group hash 110-b is not present at a required redundancy. If common data group hash 110-b is not present at a required redundancy, then module 104 adds the common data group hash to the common fields store. Processing proceeds to block 350.

At block 350, storage management module 104 adds common data group hash 110-b to output data record 110. In one example, module 104 adds common data group hash 110-b to output data record 110. Processing proceeds to block 352.

At block 352, storage management module 104 writes output data record 110 to storage device 106. In one example, processing back to block 322 for processing further write requests.

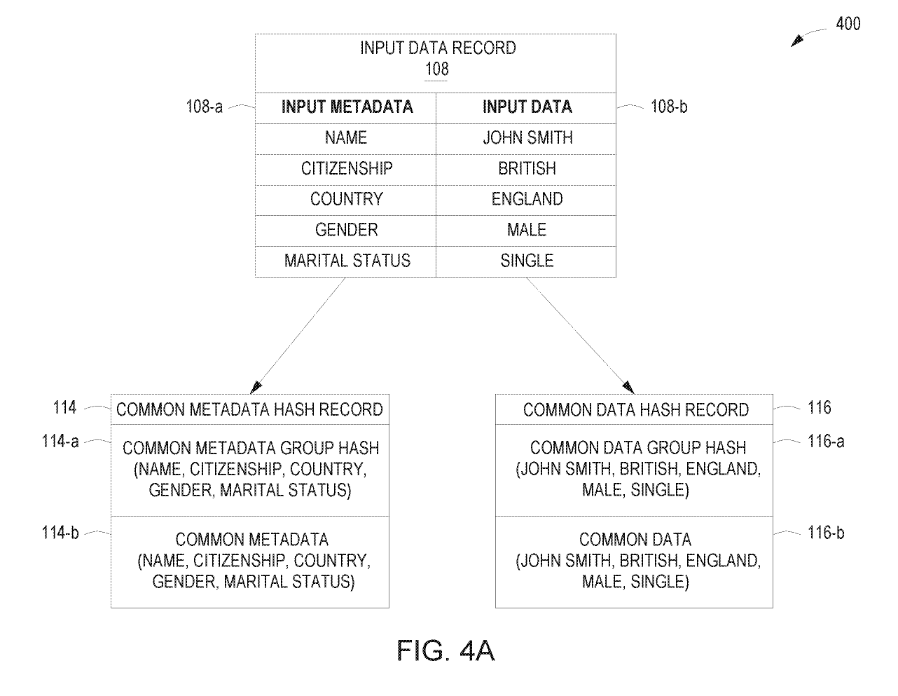

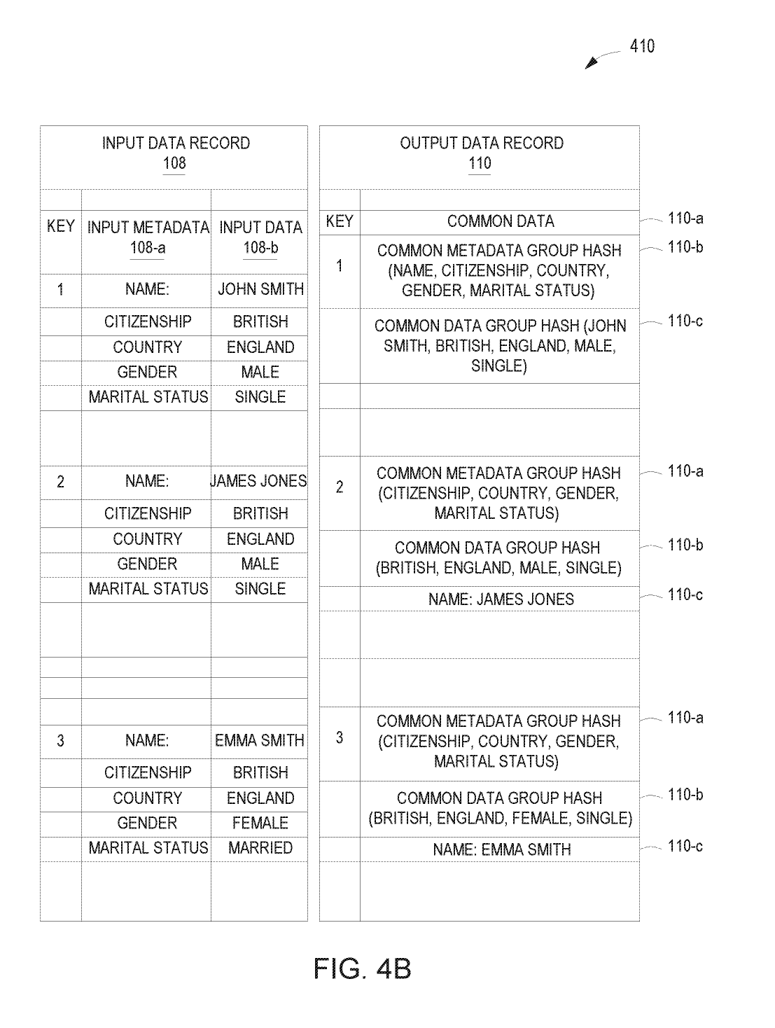

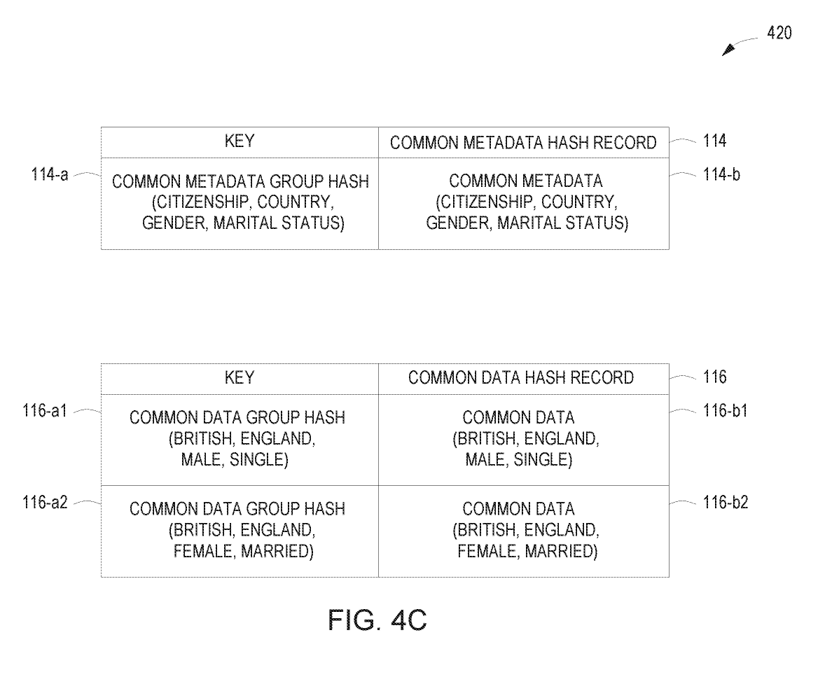

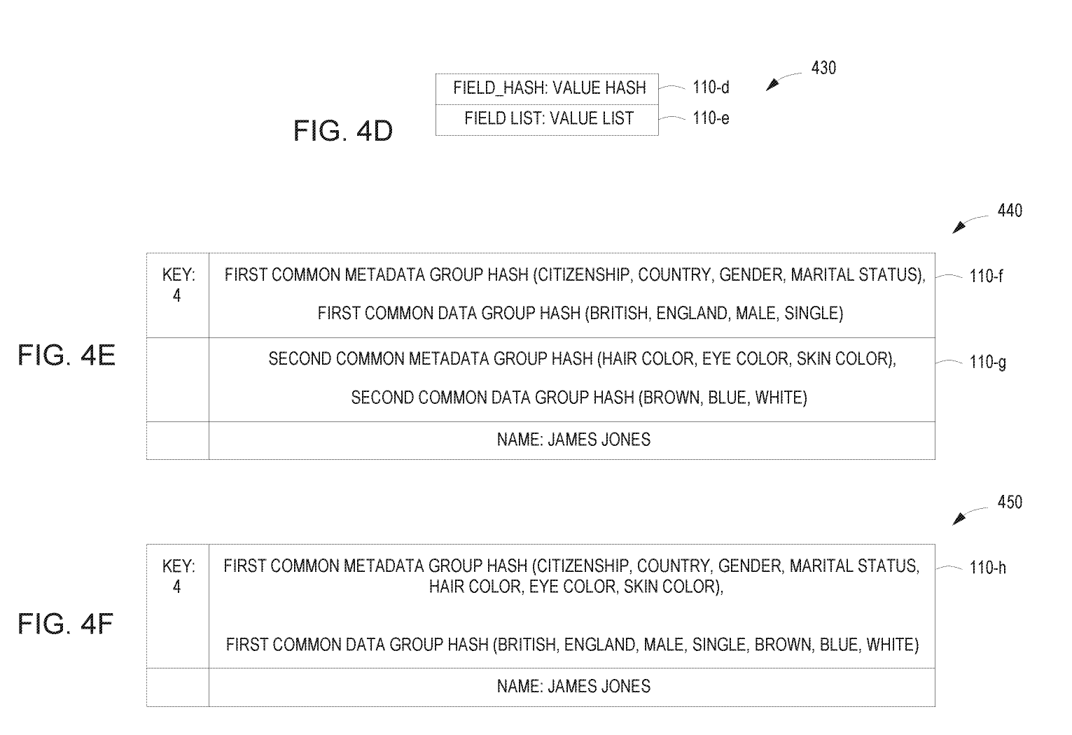

FIGS. 4A through 4F depict example diagrams for storage management of metadata in accordance with an example of the techniques of the present disclosure. To illustrate operation, it may be assumed that these diagrams employ system 100 which includes computing device 102 configured for storage management of metadata in accordance with an example of the techniques of the present disclosure and functionality described herein. To illustrate operation, it may be assumed that system 100 configures storage device 106 with a database of information that includes data records with person data and metadata about the person data. However, it should be understood that the techniques of the present disclosure may be practiced with other data types and configurations such as financial, medical and the like.

It should be understood the diagram depicted in FIGS. 4A through 4F represent generalized illustrations, and that other diagrams and processes may be added or existing processes may be removed, modified, or rearranged without departing from the scope and spirit of the present disclosure. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, Application Specific Integrated Circuits (ASICs), or other hardware components associated with the system. Furthermore, the flow charts are not intended to limit the implementation of the present disclosure, but rather the flow charts illustrate functional information to design/fabricate circuits, generate software, or use a combination of hardware and software to perform the illustrated processes.

As explained above, storage management module 104 may identify common data and metadata from input records 108 to deduplicate (remove duplicates) the records and reduce data storage requirements. In some examples, the storage device 106 may be configured to generate and store output records 110 and hash records 114, 116 as objects as part of object stores which may be used to store large amounts of metadata where parts of the metadata may be very common. In some examples, input data record 108 may have metadata 108-a which may be unordered and may be combined or mixed with other metadata which is not common.

In one example, the techniques of the present disclosure may help reduce storage requirement for this metadata by deduplicating parts or portions or subsets of the metadata that are found to be common. In this example, an object store may be configured to support or store large numbers of data records. For example, the object store may store data records of data of people and metadata having metadata fields or entries like Country, Gender, Citizenship and Marital Status which may be common and the values for these fields may also be common. In this case, to illustrate, these common metadata and data fields may be grouped and deduplicated together, as explained below.

FIG. 4A shows diagram 400 with an example of input data record 108 for processing by storage management module 104. FIG. 4B shows diagram 410 with an example data storage configuration for storing output data records 110 based on input data records 108. FIG. 3C shows diagram 430 with an example data storage configuration to store common data hash records 116 and common metadata hash records 114.

Turming to FIG. 4A, diagram 400 shows an example system 100 where it may be assumed that storage management module 104 receives from a host a write request to receive input data record 108 and write output data record 110 based on the input record. In this example, input data record 108 includes input data 108-b and input metadata 108-a corresponding to a person with a “Name” of “John Smith”. In this case, metadata “Name” is associated (and describes) the data value “John Smith”, metadata “Citizenship” is associated with data value of “British”, metadata “Country” is associated with data value of “England”, metadata “Gender” is associated with data value of “Male”, and metadata “Marital Status” is associated with data value of “Single”. It should be understood that input data record 108 is for illustrative purposes and that other examples may be employed to practice the techniques of the present disclosure. For example, input data record 108 may include a different number of data 108-b and a different number metadata 108-a and the like. In one example, input data record 108 and output data record 110 may have data that is grouped or separate according to fields which include groups of data or blocks of data.

The module 104 proceeds to calculate a hash of the sorted common input metadata: Hash (Citizenship, Country, Gender, Marital Status). The storage management module 104 also calculates a hash of the sorted common input data: Hash (British, England, Male, Single). In one example, module 104 calculates a hash based on a hash function which may include any function to map data of arbitrary size to data of fixed size. In one example, the hash function may be a Secure Hash Type 1 (SHA-1) of 20 bytes length. However, it should be understood that any hash function may be used to practice the techniques of the present disclosure.

The storage management module 104 checks if any input metadata 108-a is common metadata. It may be assumed, to illustrate operation, that input metadata 108-a is common metadata: (Citizenship, Country, Gender, Marital Status). In addition, module 104 checks if length of a common metadata group hash formed from combined common metadata is less than sum of lengths of the input metadata that are common metadata. It may be assumed, to illustrate operation, the common input metadata 108-a comprises (Citizenship, Country, Gender, Marital Status) and that the length of the common input metadata is 45 bytes. In addition, to illustrate operation, it may be assumed, that the length of common metadata group hash formed from combined common metadata is 30 bytes. In this case, the condition is true (30 bytes is less than 45 bytes) and module 104 generates a common metadata hash record 114 to include common metadata group hash 114-a and common metadata 114-b, as shown in FIG. 4A.

Furthermore, once again, storage management module 104 checks if any input metadata 108-a is common metadata. As mentioned above, it may be assumed, to illustrate operation, that input metadata 108-a is common metadata: (Citizenship, Country, Gender, Marital Status). Next, storage management module 104 checks if length of the common data group hash formed from the input common data 108-b is less than sum of lengths of the common data. It may be assumed, to illustrate operation, the common input data 108-b comprises (British, England, Male, Single) and that the length of the common input data is 45 bytes. In addition, to illustrate operation, it may be assumed, that the length of common data group hash formed from combined common data is 30 bytes. In this case, the condition is true (30 bytes is less than 45 bytes) and module 104 generates a common data hash record 116 to include common data group hash 116-a and common data 116-b, as shown in FIG. 4B

As shown in diagram 410 of FIG. 4B, storage management module 104 may generate a database of output records 110 based on input records 108. Continuing with the above example, module 104 generates an output data record 110 with a record identifier of “Key” of value “1” and “Name” of value of “John Smith” and to include the common metadata group hash 110-a and common data group hash 110-b of the respective generated common metadata 114 and data hash records 116. Also shown is an output data record 110 with a record identifier of “Key” of value “2” and “Name” of value of “James Jones” associated with respective input record 108 with a “Key” of value “2”. In addition, shown is output data record 110 with a record identifier of “Key” of value “3” and “Name” of value of “Emma Smith” associated with respective input record 108 with a “Key” of value “3”. It should be understood that the arrangement of the records of FIG. 4B are illustrative purposes and that other arrangements are possible to practice the techniques of the present disclosure.

As shown in diagram 420 of FIG. 4C, module 104 generates respective generated common metadata hash record 114 with record identifier “Key” of value of common metadata group hash 114-a and common metadata 114-b. The module 104 also generates common data hash record 116 with record identifier “Key” of value of the common data group hash 116-a1 and common data 116-b1. As explained below, module 104 generates another record 116 associated with 116-a2 and 116-b2. In one example, these records may be stored in a common fields store which may be part of a database of storage device 106.

The storage management module 104 may be able to respond to a read request to read an output data record 110. For example, to illustrate operation, module 104 may receive a request to read output record 110 associated or identified with “Name” of “John Smith” and with a “Key” of value of “1”. In this case, module 104 retrieves 3 records to reconstruct or generate the requested record. First, module 104 retrieves the requested output data record 110 (associated with “Name” of “John Smith” and “Key” of “1”) which includes any common data group hash 110-b and any common metadata group hash 110-a (and any input metadata and input data, but there is none in this example). Second, module 104 retrieves common data hash record 116 that includes common data group hash 116-a and corresponding common data 116-b. Third, module 104 retrieves common metadata hash record 114 that includes the metadata group hash 114-a and corresponding metadata 114-b. The module 104 then generates a response with the requested data by reconstructing the requested data using the three retrieved records.

Turning to FIG. 4B, in this example, input data records 108 and output data records 110 are identified with record “Keys”. In this case, input data record 108 is identified with “Key” of value of “1” which corresponds to common data record 110 identified with “Key” value of “1”. As explained above in reference to FIG. 4A, module 104 determines that input data record 108 with a “Key” value of “1” was a common data record 110 and stored it as output data record 110 with “Key” value of “1”. In addition, FIG. 4B shows input record 108 with “Key” of 2 and corresponding output record 110 associated with “Name” of “James Jones” with “Key” of “2”. Furthermore, FIG. 4B shows input record 108 with “Key” of 3 and corresponding output record 110 associated with “Name” of “Emma Smith” with “Key” of “3”.

In addition, turning to FIG. 4C, diagram 420 shows common data hash record 116 and common metadata hash records 114 corresponding to common data record 110 with “Key” value of “1” shown in FIG. 4B.

In example, turning to FIG. 4B, to illustrate operation, module 104 may receive a request to read output record 110 associated with “Name” of “James Jones” having “Key” of “2”. In this case, the entry of “Name” of “James Jones”, who is also of “Citizenship” of “British”, “Country” of “England”, “Gender” of “Male” and “Marital Status” of “Single”, references the same common metadata record 114 as common data hash record 116 as for the entry of “Name” of “John Smith” associated with “Key” of “1”. That is, in this case, as in the case above for data record 110 of “Name” of “John Smith” and “Key” of “1”, module 104 retrieves 3 records to reconstruct the requested record. First, module 104 retrieves the requested output data record 110 (associated with “Name” of “James Jones” and “Key” of “2”) which includes any common data group hash 110-b and any common metadata group hash 110-a (and any input metadata and input data, but there is none in this example). Second, module 104 retrieves common data hash record 116 that includes common data group hash 116-a and corresponding common data 116-b. Third, module 104 retrieves common metadata hash record 114 that includes the metadata group hash 114-a and corresponding metadata 114-b. The module 105 may employ a similar process when retrieving records for “Name” of “Emma Smith” or any other records.

As explained above, storage management module 104 may identify common data records to deduplicate the data records and reduce data storage requirements. In one example, if the length of a hash of the common metadata (e.g., Citizenship, Country, Gender, Marital Status) is less than the length of the input metadata (i.e., actual content of the entry or verbose entry) that it references, then storage space requirement may be reduced by referencing it by the hash so long as a sufficient number (e.g., based on application requirements such as redundancy requirements) other records have the same combination. Similarly, if the length of hash of common input data (e.g., British, England, Male, Single) is less than length of the data (i.e., verbose entry) that it references, then storage space requirements may be reduced (e.g., storage space may be saved) by referencing it by the hash.

In another example, module 104 determines the size of the common metadata and data. The module checks whether the number of entries with groups of common fields is relatively large. In this case, the deduplication techniques employed by module 104 may help reduce storage space requirements further. These techniques may be applicable to subsets of the common data that are specified. In some examples, metadata such as “Country” and data such as “England” may be referred to as fields. For example, if only “Country” and “Gender” are specified, then module 104 generates a hash of the combination of Country and Gender. In this case, module 104 may be able to determine whether storing it in a common fields store may reduce space requirements compared to storing the actual metadata and data. In one example, module 104 may check input data and metadata (fields and values) independently to determine the appropriate processing approach. For example, if the metadata or data fields comprise relatively short length fields (e.g., A, B, C), then module 104 may store these as the actual data (verbose manner). On the other hand, if the values are relatively long in length (e.g., Alpha, Bravo, Charlie), then module 104 may store these as hash data, and vice versa.

As shown in diagram 430 of FIG. 4D, in another example, module 104 may be configured to store different combinations of common metadata and data hash records based on particular fields of the metadata 110-d and data 110-e. In one example, module 104 may process the data as combinations of objects comprising of various degrees of deduplication. In one example, an output data record 110 may include multiple hash records for the common fields and also uncommon fields as well (the field list: value list rows). In this case, not all output data records have to have a single hash record. That is, common fields may be grouped according to logical groupings to help achieve higher deduplication performance. For example, separating personal details from vehicle details may achieve a higher deduplication performance than if they were combined. In this case, there will be many people with common personal details but not with both common personal details and common vehicle details. If it were to include too many common fields in the same record, then eventually every record may become unique and there may be little or no deduplication so the scope of each hash may need to be limited,

As shown in diagram 440 of FIG. 4E, in another example, module 104 may generate output records 110 with a plurality of hash values or elements. For example, output record identified as “Key” of value “4” may include a first common metadata hash 110-f that includes two hash elements: first common metadata hash (Citizenship, Country, Gender, Marital Status) and second common metadata hash (British, England, Male, Single). The output record also includes another common hash record 110-g that includes two hash elements: first common metadata hash (Hair Color, Eye Color, Skin Color) and second common data hash (Brown, Blue, White). It should be understood that other configurations and arrangements are possible to practice the techniques of the present application.

As shown in diagram 450 of FIG. 4F, in another example, module 104 may be configured to generate and update output records with combined hash records. In one example, module 104 may perform a periodic scrub process or operation to check or determine whether metadata and data are common so to update the records such as with combined hashes. For example, output record identified as “Key” of value “4” includes a common hash record 110-h that includes two hash elements: first common metadata data hash (Citizenship, Country, Gender, Marital Status, Hair Color, Eye Color, Skin Color) and first common data hash (British, England, Male, Single, Brown, Blue, White). It should be understood that other configurations and arrangements are possible to practice the techniques of the present application.

In this manner, module 104 may be able to introduce or discover new common fields and restructure or update the records to further increase storage performance. As explained above, module 104 may configure storage device 106 to arrange hash records as a separate database as part of a common fields store. In this case, the common fields store may be configured to be provided in a centralized location and cached in memory and/or stored on relatively fast storage for rapid process such as for lookup purposes. In addition, this may provide for replication of the data to provide a particular redundancy requirement.

In one example, the techniques of the present disclosure may be applied to the input data as objects as part of the common fields stores. In this case, if module 104 determines that the required redundancy for an object is greater than the number of common fields stores, then module may update the record to revert the contents to have the actual data stored (verbose). For example, if there are 3 common fields store but the storage configuration or specification is for 5 object copies, then 3 of them could use the common fields store and the other 2 could be stored with the actual data (verbose). In this case, module 104 may use the common fields store as applicable in all cases and there can be any number of them.

In another example, the techniques of the present disclosure may employ reference counting techniques. In this case, module 104 may employ reference count the entries which may require additional operations on each write but there may be options to address this. For example, module 104 may perform a periodic scrub process to check whether there are many entries referencing a subset of the common fields. If there are not many references, then module 104 may mark the entries as deprecated or decreased in importance. The module 104 may no longer need to reference common fields in new entries once they are marked as deprecated. The module 104, on the next periodic scrub process, may rewrite all deprecated common fields using the actual data (verbose) and then remove the deprecated common field records from the common fields store. The module 104 may collate the results across all locations using the same common fields store.

As explained above, storage management module 104 may be configured to determine whether an input data record is a common data record. The module 104 may determine the input data of the input data record is common data if it is same as input data of another input data record. The module 104 may determine the input metadata of the input data record is common metadata if it is same as input metadata of another input data record. The module 104 may determine the common metadata group is a sorted list of common metadata of the input data record. The module 104 may determine the common data group is a list of input data of an input data record corresponding to the common metadata group and sorted in the same order as the common metadata group. In another example, module 104 may be configured to identify common fields by having specified common fields where the system is aware of the types of metadata that will be stored and can provide hints that certain fields can be considered as common fields. The module may perform this process at any level of granularity of the data such as a cluster wide, account or container level, and the like. In another example, module 104 may be configured to identify common fields through automatic techniques such as performing periodic scrub process on the common fields store to check for common fields in the metadata and rewrite these entries to use the common fields stores where there is a possibility for space saving. Once a common field is identified, any future common data or objects containing those fields can make use of the common fields store when first stored.

In this manner, in some examples, these techniques may provide deduplication of very large collections of records of unordered metadata and may integrate into a distributed object store architecture using the same techniques.

The diagrams of FIGS. 4A through 4F are examples and should be understood that other configurations may be employed to practice the techniques of the present disclosure. For example, storage management module 104 may process a plurality of input data records 108 and generate a plurality of common data records 110 to store across a plurality of storage devices 106.

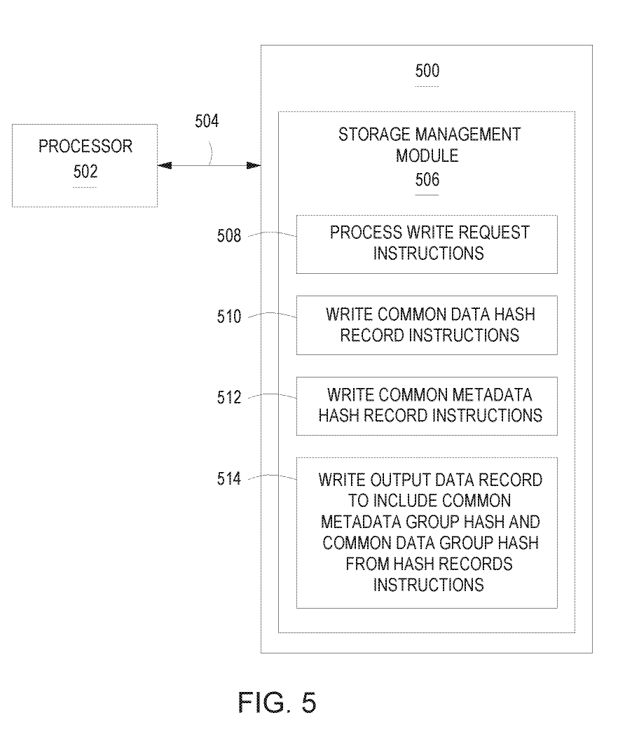

FIG. 5 is an example block diagram showing a non-transitory, computer-readable medium that stores code for operation in accordance with an example of the techniques of the present disclosure. The non-transitory, computer-readable medium is generally referred to by the reference number 500 and may be included in the system in relation to FIG. 1. The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

A processor 502 generally retrieves and executes the instructions stored in the non-transitory, computer-readable medium 500 to operate the present techniques in accordance with an example. In one example, the tangible, computer-readable medium 500 can be accessed by the processor 502 over a bus 504. A first region 506 of the non-transitory, computer-readable medium 500 may include instructions to practice storage management module 104 functionality as described herein. The module 104 functionality may be implemented in hardware, software or a combination thereof.

For example, block 508 provides instructions which may process a write request, as described herein. In one example, the instructions may process a write request to process input record 108 that includes input data 108-b and input metadata 108-a associated with respective input data, as described herein.

For example, block 510 provides instructions which may write a common data hash record 116, as described herein. In one example, the instructions may write or generate a common data hash record 116 to include common data group hash 116-a and common data 116-b, based on whether any input metadata are common metadata, and if length of the common data group hash formed from the common data is less than sum of lengths of the common data, as described herein.

For example, block 512 provides instructions which may write a common metadata hash record 114, as described herein. In one example, the instructions may write or generate a common metadata hash record 114 to include common metadata group hash 114-a and common metadata 114-b, based on whether any input metadata are common metadata, and if length of the common metadata group hash formed from combined common metadata is less than sum of lengths of the input metadata that are common metadata, as described herein.

For example, block 514 provides instructions which may write an output data record 110 to include common metadata group hash 110-a and common data group hash 110-b from hash records, as described herein. In one example, the instructions may write or generate an output data record 110 to include the common metadata group hash 110-a and common data group hash 110-b of the respective generated common metadata hash and common data hash records and to include all input metadata and input data 110-c not included in the corresponding generated common metadata hash and common data hash records, as described herein.

The blocks of FIG. 5 shows example blocks and it should be understood that other instructions may be employed to practice the techniques of the present disclosure. For example, storage management module 104 may be configured to include instructions to, in response to an update request to update an output data record: retrieve the requested output data record which includes a common data group hash and a common metadata group hash, retrieve a common data hash record that includes the common data group hash and corresponding common data, retrieve a common metadata hash record that includes the common metadata group hash and corresponding common metadata, and rewrite the retrieved output data record which includes an updated common data group hash and updated metadata group hash.

In another example, computer-readable medium 500 may include instructions to, in response to a read request to read an output data record: retrieve the requested output data record which includes any common data group hash, any common metadata group hash, and any input metadata and input data, retrieve any common data hash record that includes the common data group hash and corresponding common data, and retrieve any common metadata hash record that includes the metadata group hash and corresponding metadata.

In another example, computer-readable medium 500 may be configured to include instructions to determine the input data of the input data record is common data if it is same as input data another input data record, and determine the input metadata of the input data record is common metadata if it is same as input metadata of another input data record.

In another example, computer-readable medium 500 may be configured to include instructions to determine the common metadata group is a sorted list of common metadata of the input data record, and determine the common data group is a list of input data of an input data record corresponding to the common metadata group and sorted in the same order as the common metadata group.

Although shown as contiguous blocks, the software components can be stored in any order or configuration. For example, if the non-transitory, computer-readable medium 500 is a hard drive, the software components can be stored in non-contiguous, or even overlapping, sectors.

As used herein, a “processor” may include processor resources such as at least one of a Central Processing Unit (CPU), a semiconductor-based microprocessor, a Graphics Processing Unit (GPU), a Field-Programmable Gate Array (FPGA) configured to retrieve and execute instructions, other electronic circuitry suitable for the retrieval and execution instructions stored on a computer-readable medium, or a combination thereof. The processor fetches, decodes, and executes instructions stored on medium 500 to perform the functionalities described below. In other examples, the functionalities of any of the instructions of medium 500 may be implemented in the form of electronic circuitry, in the form of executable instructions encoded on a computer-readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable medium described herein may be non-transitory. In examples described herein, a computer-readable medium or media is part of an article (or article of manufacture). An article or article of manufacture may refer to any manufactured single component or multiple components. The medium may be located either in the system executing the computer-readable instructions, or remote from but accessible to the system (e.g., via a computer network) for execution. In the example of FIG. 5, medium 500 may be implemented by one computer-readable medium, or multiple computer-readable media.

In some examples, instructions 508-514 may be part of an installation package that, when installed, may be executed by processor 502 to implement the functionalities described herein in relation to instructions 508-514. In such examples, medium 500 may be a portable medium, such as a CD, DVD, or flash drive, or a memory maintained by a server from which the installation package can be downloaded and installed. In other examples, instructions 508-514 may be part of an application, applications, or component(s) already installed on computing device 102 including processor 502. In such examples, the medium 500 may include memory such as a hard drive, solid state drive, or the like. In some examples, functionalities described herein in relation to FIGS. 1 through 5 may be provided in combination with functionalities described herein in relation to any of FIGS. 1 through 5.

The foregoing describes a novel and previously unforeseen approach for storage management. While the above disclosure has been shown and described with reference to the foregoing examples, it should be understood that other forms, details, and implementations may be made without departing from the spirit and scope of this disclosure.

What is claimed is:

1. A computing device for storage management of metadata, the computing device comprising:
a storage management module is to:
in response to a write request to write an input data record that includes input data and input metadata associated with respective input data:
if any input metadata are common metadata, and if length of a common metadata group hash formed from combined common metadata is less than sum of lengths of the input metadata that are common metadata, then generate a common metadata hash record to include the common metadata group hash and the common metadata,
if any input metadata are common metadata, and if length of a common data group hash formed from the common data is less than sum of lengths of the common data, then generate a common data hash record to include the common data group hash and the common data, and
generate an output data record to include the common metadata group hash and common data group hash of the respective generated common metadata and data hash records and to include all input metadata and input data not included in the corresponding generated common metadata and data hash records.

2. The computing device of claim 1, wherein the storage management module is to, in response to an update request to update an output data record:
retrieve the requested output data record which includes a common data group hash and a common metadata group hash;
retrieve a common data hash record that includes the common data group hash and corresponding common data;
retrieve a common metadata hash record that includes the common metadata group hash and corresponding common metadata; and
rewrite the retrieved output data record which includes an updated common data group hash and updated metadata group hash.

3. The computing device of claim 1, wherein the storage management module is to, in response to a read request to read an output data record:
retrieve the requested output data record which includes any common data group hash, any common metadata group hash, and any input metadata and input data;
retrieve any common data hash record that includes the common data group hash and corresponding common data; and
retrieve any common metadata hash record that includes the metadata group hash and corresponding metadata.

4. The computing device of claim 1, wherein the storage management module is to:
determine the input data of the input data record is common data if it is same as input data another input data record; and
determine the input metadata of the input data record is common metadata if it is same as input metadata of another input data record.

5. The computing device of claim 1, wherein the storage management module is to:
determine the common metadata group is a sorted list of common metadata of the input data record; and
determine the common data group is a list of input data of an input data record corresponding to the common metadata group and sorted in the same order as the common metadata group.

6. A method of storage management of metadata, the method comprising:
processing a write request to write an input data record that includes input data and input metadata associated with respective input data;
generating a common metadata hash record to include common metadata group hash and common metadata, based on whether any input metadata are common metadata, and if length of the common metadata group hash formed from combined common metadata is less than sum of lengths of the input metadata that are common metadata;
generating a common data hash record to include common data group hash and common data, based on whether any input metadata are common metadata, and if length of the common data group hash formed from the common data is less than sum of lengths of the common data; and
generating an output data record to include the common metadata group hash and common data group hash of the respective generated common metadata and data hash records and to include all input metadata and input data not included in the corresponding generated common metadata hash and common data hash records.

7. The method of claim 6, further comprising, in response to an update request to update an output data record:
retrieving the requested output data record which includes a common data group hash and a common metadata group hash;
retrieving a common data hash record that includes the common data group hash and corresponding common data;
retrieving a common metadata hash record that includes the common metadata group hash and corresponding common metadata; and
rewriting the retrieved output data record which includes an updated common data group hash and updated metadata group hash.

8. The method of claim 6, further comprising, in response to a read request to read an output data record:
retrieving the requested output data record which includes any common data group hash, any common metadata group hash, and any input metadata and input data;
retrieving any common data hash record that includes the common data group hash and corresponding common data; and
retrieving any common metadata hash record that includes the metadata group hash and corresponding metadata.

9. The method of claim 6, further comprising:
determining the input data of the input data record is common data if it is same as input data another input data record; and
determining the input metadata of the input data record is common metadata if it is same as input metadata of another input data record.

10. The method of claim 6, further comprising:
determining the common metadata group is a sorted list of common metadata of the input data record; and
determining the common data group is a list of input data of an input data record corresponding to the common metadata group and sorted in the same order as the common metadata group.

11. A non-transitory computer-readable medium having computer executable instructions stored thereon for storage management of metadata, the instructions are executable by a processor to:
process a write request to write an input data record that includes input data and input metadata associated with respective input data;
write a common data hash record to include common data group hash and common data, based on whether any input metadata are common metadata, and if length of the common data group hash formed from the common data is less than sum of lengths of the common data; and
write a common metadata hash record to include common metadata group hash and common metadata, based on whether any input metadata are common metadata, and if length of the common metadata group hash formed from combined common metadata is less than sum of lengths of the input metadata that are common metadata; and
write an output data record to include the common metadata group hash and common data group hash of the respective generated common metadata hash and common data hash records and to include all input metadata and input data not included in the corresponding generated common metadata hash and common data hash records.

12. The non-transitory computer-readable medium of claim 11, further comprising instructions that if executed cause a processor to: in response to an update request to update an output data record:
retrieve the requested output data record which includes a common data group hash and a common metadata group hash;
retrieve a common data hash record that includes the common data group hash and corresponding common data;
retrieve a common metadata hash record that includes the common metadata group hash and corresponding common metadata; and
rewrite the retrieved output data record which includes an updated common data group hash and updated metadata group hash.

13. The non-transitory computer-readable medium of claim 11, further comprising instructions that if executed cause a processor to: in response to a read request to read an output data record:
retrieve the requested output data record which includes any common data group hash, any common metadata group hash, and any input metadata and input data;
retrieve any common data hash record that includes the common data group hash and corresponding common data; and
retrieve any common metadata hash record that includes the metadata group hash and corresponding metadata.

14. The non-transitory computer-readable medium of claim 11 further comprising instructions that if executed cause a processor to:
determine the input data of the input data record is common data if it is same as input data of another input data record; and
determine the input metadata of the input data record is common metadata if it is same as input metadata of another input data record.

15. The non-transitory computer-readable medium of claim 11 further comprising instructions that if executed cause a processor to:
determine the common metadata group is a sorted list of common metadata of the input data record; and
determine the common data group is a list of input data of an input data record corresponding to the common metadata group and sorted in the same order as the common metadata group.
